(19) United States
(12) Patent Application Publication
(10) Pub. No.: US 2007/0146479 A1
(43) Pub. Date: Jun. 28, 2007

(54) Integrated video control chipset

(76) Inventors: Chen-Jen Huang, Hsinhua (TW); Chung-Hsun Huang, Sinhua Township (TW); Kuei-Hsiang Chen, Sinhua Township (TW)

Correspondence Address: J.C. Patents, Suite 250, 4 Venture, Irvine, CA, 92618, US

(21) Appl. No.: 11/373,856

(22) Filed: Mar. 10, 2006

(30) Foreign Application Priority Data
Mar. 11, 2005 (TW) 94107436

(51) Int. Cl. H04N 13/04

(52) U.S. Cl. 348/51

(57) ABSTRACT

A control chipset for a video display apparatus is provided. The control chipset is coupled to a frame buffer and a display unit. The control chipset comprises: a scaler for receiving and processing an input video signal to generate a scaled video signal; a three-dimensional (3D) video enhancing unit for receiving and processing the scaled video signal to generate an enhanced video signal; an overdrive unit for receiving and processing the enhanced video signal to generate an overdriven video signal; a timing controller for generating a timing control signal, receiving the overdriven video signal, and transferring the timing control signal and the overdriven video signal to the display unit; and a memory controller. The scaler, the 3D video enhancing unit, and the overdriven unit access the frame buffer through the same memory controller, and data accessed by the overdrive unit is compressed.

### BACKGROUND OF THE INVENTION

1. Field of the Invention

The present invention relates to an integrated video control chipset. More particularly, the present invention relates to an integrated video control chipset for a video display apparatus.

2. Description of Related Art

There are at least two main categories of TV sets: CRT and flat pane TV. The liquid crystal display (LCD) TV is a major type of flat panel TV. Since the LCD TV has the advantages of low radiation, small volume, low power consumption and environmentally friendly, and so on, the LCD TV has replaced the CRT TV in the recent years.

FIG. 1 is a block diagram of the circuit of a control chipset for the conventional LCD TV. As shown in FIG. 1, a control chipset 10 for the LCD TV includes a video processor 20 and an overdrive timing controller 30. The video processor 20 is coupled to a first frame buffer 24. The overdrive timing controller 30 is coupled to a second frame buffer 34. The frame buffer 24/34 is, for example, implemented by a synchronous dynamic random access memory (SDRAM).

The video processor 20 includes a scaler 21, a three-dimensional (3D) video enhancing unit 22, and a first memory controller 23.

The scaler 21 receives an input signal IN. The 21 performs an appropriate video process on the input signal IN, for example, white balance and gamma correction, and so on. The scaler 21 receives the input signal IN and outputs the video signal IN_SC to the 3D video enhancing unit 22.

The 3D video enhancing unit 22 performs a 3D video enhancement on the 3D video signal. The 3D video enhancing unit 22 outputs the video signal IN_EN to the overdrive timing controller 30.

The scaler 21 and the 3D video enhancing unit 22 access the data of the first frame buffer 24 through the first memory controller 23. A bidirectional signal M_SC exists between the first memory controller 23 and the scaler 21 and includes frame data a data enable signal, a horizontal synchronizing signal, and a vertical synchronizing signal, etc. Similarly, a bidirectional signal M_EN exists between the first memory controller 23 and the 3D video enhancing unit 22 and includes frame data a data enable signal, a horizontal synchronizing signal, and a vertical synchronizing signal an the like.

Typically, the 3D video enhancing unit 22 accesses data in the first frame buffer 24 more frequently than the scaler 21. Only when the scaler 21 performs a frame-rate conversion (FRC), the scaler 21 accesses the data in the first flame buffer 24.

The memory controller 23 sends a frame access, signal FB_1 to access the data in the first frame buffer 24. The frame access signal FB_1 includes a frame data and an address signal, and so on.

The overdrive timing controller 30 includes an overdrive unit 31, a timing controller (TCON) 32, and a second memory controller 33.

The overdrive unit 31 has a function of response time compensation (RTC). The overdrive unit 31 receives the video signal IN_EN, and outputs an overdriven signal IN_OD. A bidirectional signal M_OD exists between the second memory controller 33 and the overdrive unit 31 and includes the frame data the data enable signal, the horizontal synchronization signal, and the vertical synchronizing signal, and so on.

When transferring the video signal IN_OD from the overdrive unit to the display unit (e.g. an LCD panel). 40, the timing controller 32 also sends a control signal CON altogether. The control signal CON is used to control the timing of the display unit 40 when displaying the picture.

The overdrive unit 31 and the timing controller 32 access data of the second frame buffer 34 through the second memory controller 33. The second memory controller 33 sends a fame access signal FB_2 to access data of the second frame buffer 34. The frame access signal FB_2 includes the frame data and the address signal, and so on.

The video processor and the overdrive timing controller in the conventional control chipset are all stand-alone chips. The routing on the system-board (e.g.; printed circuit board (PCB)) connects the two chips together. The video processor and the overdrive timing controller must be respectively provided with an exclusive memory controller and an external frame buffer. This causes an increase of the cost of routing on the PCB and the package cost of providing, an interface between the two chips and the frame buffer.

Therefore, an integrated control chipset having the same effect of providing the stand alone control chipset while reducing the routing cost and package cost is needed.

### SUMMARY OF THE INVENTION

Accordingly, the object of the present invention is to provide an integrated control chipset for a video display apparatus, which can reduce the component cost, the package cost, and the system-board routing cost.

The present invention provides an integrated control chipset for a video display apparatus, suitable for lowering the operation frequency of memory by the use of the data compression method.

The present invention provides a control chipset for a video display apparatus is provided. The control chipset is coupled to a frame buffer and a display unit. The control chipset comprises: a scaler for receiving and processing an input video signal to generate a scaled video signal; a three-dimensional (3D) video enhancing unit for receiving and processing the scaled video signal to generate an enhanced video signal; an overdrive unit for receiving and processing the enhanced video signal to generate an overdriven video signal; a timing controller for generating an timing control signal, receiving the overdriven video signal, and transferring the timing control signal and the overdriven video signal to the display unit; and a memory controller. The scaler, the 3D video enhancing unit, and the overdriven unit access the frame buffer through the same memory controller a data accessed by the overdrive unit is compressed.

Still, the present invention provides a control chipset for a video display apparatus, the control chipset coupled to a frame buffer and a display unit. The control chipset comprises: a scaler for receiving and processing an input video signal to generate a scaled video signal; a three-dimensional (3D) video enhancing unit for receiving and processing the scaled video signal to generate an enhanced video signal an overdrive unit for receiving and processing the enhanced video signal to generate an overdriven video signal; a timing controller for generating a timing control signal, receiving the overdriven video signal, and transferring the timing control signal and the overdriven video signal to the display unit; and a memory controller shared by the scaler, the 3D video enhancing unit and the overdriven unit, and served as an interface for the scaler, the 3D video enhancing unit, and the overdriven unit to access the frame buffer.

Still, the present invention provides a control chipset for a video display apparatus, the control chipset coupled to a frame buffer and a display unit. The control chipset comprises: a video scaling and enhancing module performing scaling and video enhancement on a received input video signal; an overdrive timing control module performing overdriving and timing-control on an output of the video scaling and enhancing module; and a memory controller shared by the video scaling and enhancing module and the overdrive timing control module, and served as a an interface for the video scaling and enhancing module, and the overdrive timing control module to access the frame buffer.

In order to the make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWING

FIG. 1 is a block diagram of the circuit of the prior control chipset for an LCD TV.

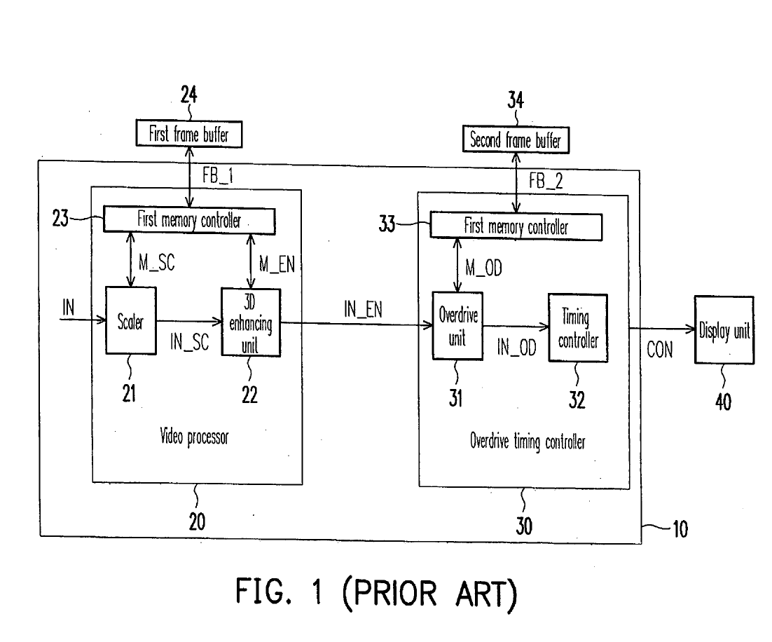

FIG. 2 is a block diagram of the circuit of the integrated control chipset according to the preferred embodiment of the present invention.

### DESCRIPTION OF EMBODIMENTS

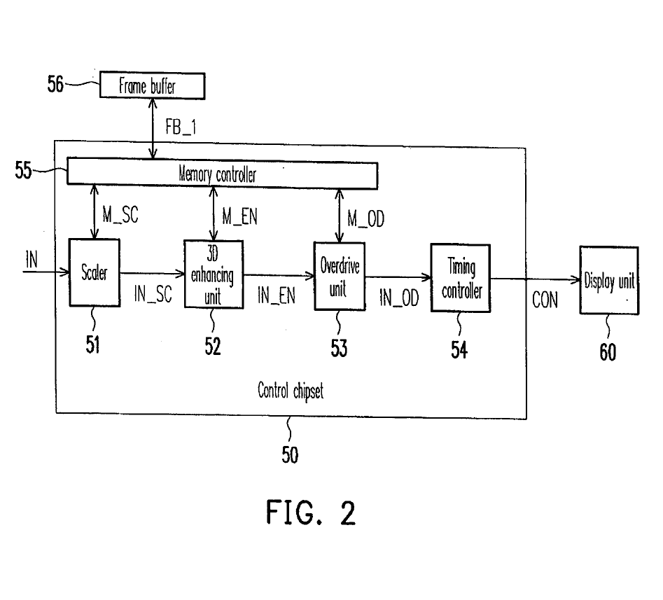

Referring to FIG. 2, it is a block diagram of the circuit of the integrated control chipset for an LCD TV according to the presents invention.

As shown in FIG. 2, a control chipset 50 includes a scaler 51, a 3D video enhancing unit 52, an overdrive unit 53, a timing-controller 54, and a memory controller 55. The control chipset 50 is coupled to a frame buffer 56 and a display unit 60

The scaler 51 receives an input signal IN. The input signal IN is provided by, for example, an analog/digital converter (ADC) or a digital video interface (DVI). The scaler 51 performs the FRC, e.g. converting a signal with a frequency of 60 Hz to a signal with a frequency of 75 Hz. During performing the FRC, the scaler 51 must access the frame data in the frame buffer 56. The scaler 51 converts pictures of various resolutions into those of the native resolution. If the original picture is too small, the scaler 51 will enlarge the picture by using a process of interpolation, so as to fit the size of the display panel. If the color depth of a certain picture exceeds the color depth of the display, the scaler 51 utilizes a simulation technology, e.g. high frequency dithering technology to improve the color display capability. The scaler 51 receives the input signal IN and outputs a video signal IN_SC to the 3D video enhancing unit 52. A bidirectional signal M_SC exists between the memory controller 55 and the scaler 51 and includes the frame data, the data enable signal the horizontal synchronizing signal, and the vertical synchronizing signal, and so on.

The 3D video enhancing unit 52 performs the 3D video enhancement including the 3D noise reduction and the 3D de-interlace, and the like on the 3D video signal. The 3D video enhancing unit 52 receives the video signal IN_SC and outputs a video signal IN_EN to the overdrive unit 53. A bidirectional signal M_EN exists between the memory controller 55 and the 3D video enhancing unit 52 and includes the frame data, the data enable signal, the horizontal synchronizing signal, and the vertical synchronizing signal, and so on.

The overdrive unit 53 has a function of RTC. The function of RTC can shorten the response time of the LCD display, thus avoiding the blur of the moving scene of the picture, which is the feature of the necessary function of the LCD TV. The overdrive unit 53 receives the video signal IN_EN, and outputs an overdriven video signal IN_OD. A bidirectional signal M_OD exists between the memory controller 55 and the overdrive unit 53 and includes the frame data, the data enable signal, the horizontal synchronizing signal, and the vertical synchronizing signal, and so on.

The memory controller 55 sends a frame access signal FB access the data of the frame buffer 56. The access signal FB includes the frame data and the address signal, and so on.

When transferring the video signal IN_OD from the overdrive unit 53 to the display unit (e.g. an LCD panel) 40, the timing controller, 54 also sends a control signal CON altogether. The control signal CON is used to control the timing of the display unit (e.g. an LCD panel) 60 when displaying the picture.

The frame buffer 56 is implemented, for example, by a SDRAM.

It is known from the above that the present invention integrates the video processor and the overdrive timing controller into a single chip.

In the present invention, since the video processor and the overdrive timing controller are integrated into a single chip, it is necessary to consider whether or not the band width of the memory (i.e. the frame buffer) is wide enough.

Generally speaking, the operation occupying the band wide of the memory includes the FRC, 3D noise reduction, de-interlace, and overdrive and the like. If the burst length of the memory is 24 clock periods, each burst read operation requires additional 6 clock periods to enable and precharge, etc., and each burst write operation requires additional 5 clock periods. If the operations are performed in sync, the required operation frequency of the memory is up to 270 MHz. The memory of such a high frequency may incur a large increase of the cost of the integrated control chipset.

Therefore, the data compression method can be used to alleviate the problem of the low bandwidth and high operation frequency of the memory. If the read/write data quantity of the overdrive operation is compressed by 50%, the required operation frequency of the memory is lowered to 170 MHz, such that the cost of the integrated control chipset is further reduced. This object is achieved by using the conventional data compression method that will not be described herein again.

It is known from the above that the present invention is characterized in that (1) the video processor and the overdrive timing controller are integrated to a single chip; (2) the integrated control chipset only requires a single built-in memory controller; and (3) the integrated control chipset only requires an external frame buffer.

In comparison with the conventional art, the advantage of the present invention lies in that only one interface circuit are required between the control circuit and the frame buffer such that the package cost is significantly lowered.

The present invention only employs a single memory controller and a single frame buffer, thereby further lowering the component-cost.

Due to the integrated control chipset, the cost of routing on the PCB is further reduced.

In addition to the LCD TV, the present invention an be applied to LCD monitors and the like.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A control chipset for a video display apparatus, the control chipset coupled to a frame buffer and a display unit, the control chipset comprising:
a scaler for receiving and processing an input video signal to generate a scaled video signal;
a three-dimensional (3D) video enhancing unit for receiving and processing the scaled video signal to generate an enhanced video signal;
an overdrive unit for receiving and processing the enhanced video signal to generate an overdriven video signal;
a timing controller for generating a timing control signal, receiving the overdriven video signal, and transferring the timing control signal and the overdriven video signal to the display unit; and
a memory controller;
wherein the scaler, the 3D video enhancing unit, and the overdriven unit access the frame buffer through the same memory controller, and data accessed by the overdrive unit is compressed.

2. The control chipset as claimed in claim 1, wherein the scaler performs a frame-rate conversion (FRC) on the input video signal.

3. The control chipset as claimed in claim 1, wherein the 3D video enhancing unit performs a 3D noise reduction and/or 3D de-interlace on the scaled video signal.

4. The control chipset as claimed in claim 1, wherein the video display apparatus comprises an LCD TV.

5. The control chipset as claimed in claim 1, wherein the video display apparatus comprises an LCD monitor.

6. A control chipset for a video display apparatus, the control chipset coupled to a frame buffer and a display unit, the control chipset comprising:
a scaler for receiving and processing an input video signal to generate a scaled video signal;
a three-dimensional (3D) video enhancing unit for receiving and processing the scaled video signal to generate an enhanced video signal;
an overdrive unit for receiving and processing the enhanced video signal to generate an overdriven video signal;
a timing controller for generating a timing control signal, receiving the overdriven video signal, and transferring the timing control signal and the overdriven video signal to the display unit; and
a memory controller shared by the scaler, the 3D video enhancing unit and the overdriven unit, and served as an interface for the scaler, the 3D video enhancing unit, and the overdriven unit to access the frame buffer.

7. The control chipset as claimed in claim 6, wherein the scaler performs an FRC on the input video signal.

8. The control chipset as claimed in claim 6, wherein the 3D video enhancing unit performs a 3D noise reduction and/or 3D de-interlace on the scaled video signal.

9. The control chipset as claimed in claim 6, wherein the video display apparatus comprises an LCD TV.

10. The control chipset as claimed in claim 6, wherein the video display apparatus comprises an LCD monitor.

11. A control chipset for a video display apparatus, the control chipset coupled to a frame buffer and a display unit, the control chipset comprising:
a video scaling and enhancing module performing scaling and video enhancement on a received input video signal;
an overdrive timing control module performing overdriving and timing-control on an output of the video scaling and enhancing module; and
a memory controller shared by the video scaling and enhancing module and the overdrive timing control module, and served as an interface for the video scaling and enhancing module, and the overdrive tinning control module to access the frame buffer.

12. The control chipset as claimed in claim 1 wherein the video scaling and enhancing module comprises:
a scaler for receiving and processing the input video signal to generate a scaled video signal; and
a 3D video enhancing unit for receiving and processing the scaled video signal to generate an enhanced video signal.

13. The control chipset as claimed in claim 12, wherein the overdrive timing control module comprises:
an overdrive unit for receiving and processing the enhanced video signal to generate an overdriven video signal; and
a timing controller for generating a timing control signal, receiving the overdriven video signal, and transferring the timing control signal and the overdriven video signal to the display unit.

14. The control chipset as claimed in claim 13, wherein data accessed by the overdrive unit is compressed.

15. The control chipset as claimed in claim 13, wherein the scaler performs an FRC on the input video signal.

16. The control chipset as claimed in claim 13, wherein the 3D video enhancing unit performs a 3D noise reduction and/or 3D de-interlace on the scaled video signal.

17. The control chipset as claimed in claim 11, wherein the video display apparatus comprises an LCD TV.

18. The control chipset as claimed in claim 11, wherein the video display apparatus comprises an LCD monitor.

19. A control chipset for a video display apparatus, the control chipset coupled to a frame buffer, the control chipset comprising:
a three-dimensional (3D) video enhancing unit for receiving and processing a first video signal;
an overdrive unit for receiving and processing a second video signal; and
a memory controller;
wherein the 3D video enhancing unit and the overdriven unit access the frame buffer through the same memory controller.

20. A control chipset for a video display apparatus, the control chipset coupled to a frame buffer and a display unit, the control chipset comprising:
a scaler for receiving and processing an input video signal to generate a scaled video signal;
an overdrive unit for receiving and processing the enhanced video signal to generate an overdriven video signal; and
a memory controller;
wherein the scaler and the overdriven unit access the frame buffer through the same memory controller.
